(19) United States
(12) Patent Application Publication
(10) Pub. No.: US 2024/0281925 A1
(43) Pub. Date: Aug. 22, 2024

(54) INFORMATION PROCESSING DEVICE, INFORMATION PROCESSING METHOD, AND PROGRAM

(71) Applicant: SONY GROUP CORPORATION, TOKYO (JP)

(72) Inventor: KEISUKE CHIDA, TOKYO (JP)

(21) Appl. No.: 18/569,745

(22) PCT Filed: Jan. 21, 2022
(86) PCT No.: PCT/JP2022/002081

§ 371 Date: Dec. 13, 2023

(30) Foreign Application Priority Data
Jun. 23, 2021 (JP) 2021-103775

(51) Int. Cl. G06T 3/4046; G06T 3/4053; G06V 10/82; G06V 40/16

(52) U.S. Cl. CPC G06T 3/4046; G06T 3/4053; G06V 10/82; G06V 40/161; G06V 40/171; G06V 40/172

(57) ABSTRACT

The information processing device (IP) includes a human face determination network (PN) and a super-resolution network (SRN). The human face determination network (PN) calculates a human face matching degree between an input image (IM_{I}) before being subjected to super-resolution processing and an input image (IM_{I}) after being subjected to the super-resolution processing. The super-resolution network (SRN) adjusts a generation force of the super-resolution processing based on the human face matching degree.

### FIELD

The present invention relates to an information processing device, an information processing method, and a program.

### BACKGROUND

A super-resolution technique for outputting an input image with high resolution is known. Recently, a super-resolution network capable of reproducing fine information that is difficult to distinguish from an input image using an image generation method called a Generative Adversarial System (GAN) has also been proposed.

### CITATION LIST

### Patent Literature

Patent Literature 1: JP H10-240920 A

### Non Patent Literature

Non Patent Literature 1: [online], Few-shot Video-to-Video Synthesis, [Searched on Jun. 4, 2021], Internet <URL:https://nvlabs.github.io/few-shot-vid2vid/main.pdf>

### SUMMARY

### Technical Problem

In the super-resolution network using the GAN, a signal having a high-frequency component not included in the input signal is newly generated based on the learning result. A super-resolution network having a higher signal generation capability (generation force) can generate a high-resolution image. However, when a signal not included in the input signal is added, a deviation from the input image may occur. For example, in a case where a human face is targeted, a human face may change due to a slight shift in the shapes of the eyes and the mouth.

Therefore, the present disclosure proposes an information processing device, an information processing method, and a program capable of suppressing a change in a human face due to super-resolution processing.

### Solution to Problem

According to the present disclosure, an information processing device is provided that comprises: a human face determination network that calculates a human face matching degree between an input image before being subjected to super-resolution processing and the input image after being subjected to the super-resolution processing; and a super-resolution network that adjusts a generation force of the super-resolution processing based on the human face matching degree. According to the present disclosure, an information processing method in which an information process of the information processing device is executed by a computer, and a program for causing the computer to execute the information process of the information processing device, are provided.

### BRIEF DESCRIPTION OF DRAWINGS

FIG. 1 is a diagram illustrating an example of image processing using a super-resolution technique.

FIG. 2 is a diagram illustrating a change in a human face due to super-resolution processing.

FIG. 3 is a diagram illustrating a change in a human face due to super-resolution processing.

FIG. 4 is a diagram illustrating an example of a conventional super-resolution processing system.

FIG. 5 is a diagram illustrating an example of a conventional super-resolution processing system.

FIG. 6 is a diagram illustrating a configuration of an information processing device according to a first embodiment.

FIG. 7 is a diagram illustrating an example of a relationship between a human face matching degree and a generation force control value.

FIG. 8 is a flowchart illustrating an example of information processing of the information processing device.

FIG. 9 is a diagram illustrating an example of a learning method of a super-resolution network.

FIG. 10 is a diagram illustrating an example of a combination of weights corresponding to a generation force level.

FIG. 11 is a diagram illustrating a configuration of an information processing device according to a second embodiment.

FIG. 12 is a diagram illustrating an example of a method of comparing a posture, a size, and a position of a face.

FIG. 13 is a flowchart illustrating an example of information processing of the information processing device.

FIG. 14 is a diagram illustrating a hardware configuration example of the information processing device.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

Note that the description will be given in the following order.
[1. Background]
[1-1. Super-resolution technique]
[1-2. Change in human face due to super-resolution processing]
[2. First embodiment]
[2-1. Configuration of information processing device]
[2-2. Information processing method]
[2-3. Learning method]
[2-4. Effects]
[3. Second embodiment]
[3-1. Configuration of information processing device]
[3-2. Information processing method]
[3-3. Effects]
[4. Hardware configuration example]

### 1. Background

### [1-1. Super-Resolution Technique]

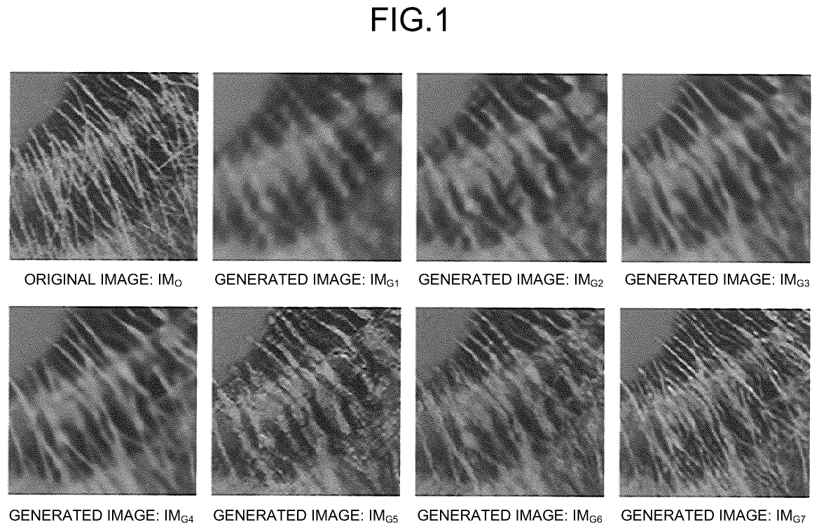

FIG. 1 is a diagram illustrating an example of image processing (super-resolution processing) using a super-resolution technique.

The upper left image in FIG. 1 is an original image (high-resolution image) IM_{O}. Generated images IM_{G1} to IM_{G7} are obtained by restoring the original image IM_{O} having a resolution reduced by compression or the like by super-resolution processing. The generation force of super-resolution processing is increased from the generated image IM_{G1} toward the generated image IM_{G7}. Note that the generation force means the ability to newly generate a high-frequency component signal that is not included in the input signal. As the generation force is stronger, a high-resolution image can be obtained.

In the super-resolution processing with weak generation force, information (such as a pattern) lost in the input signal is not sufficiently restored. However, since the difference from the input signal is small, it is difficult to generate an image deviated from the original image IM_{O}. In the super-resolution processing with strong generation force, even information lost in the input signal is generated, in a manner that an image close to the original image IM_{O} can be obtained. However, if the signal is not correctly generated, there is a possibility that an image deviated from the original image IM_{O} is generated.

For example, in the example of FIG. 1, images of a beard of a baboon are illustrated. Many fine beards are displayed in the original image IM_{O}. The blur of the beard decreases from the generated image IMG₁ toward the generated image IMG₇, and the generated image IMG₇ has the same resolution as that of the original image IM_{O}. However, in the generated image IMG7, the shape of each beard is slightly different, and the image has an atmosphere slightly different from that of the original image IM_{O}. Such a slight change in the generated image appears as a change in a human face when a human face is to be processed.

### [1-2. Change in Human Face Due to Super-Resolution Processing]

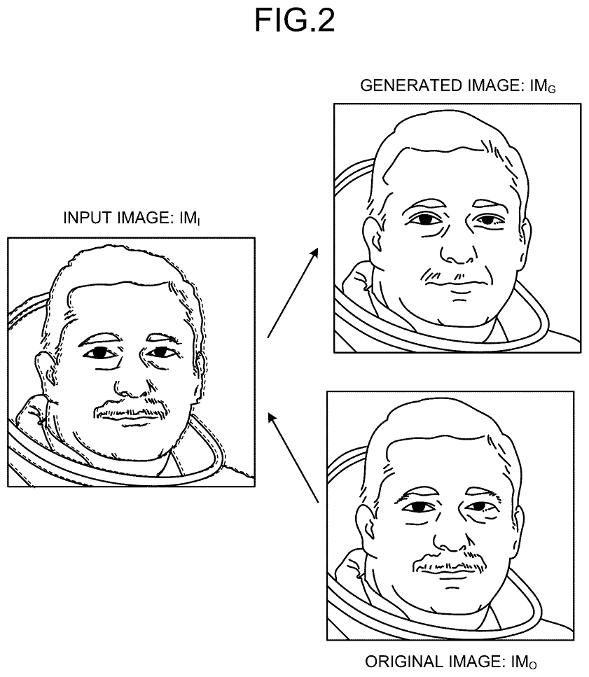

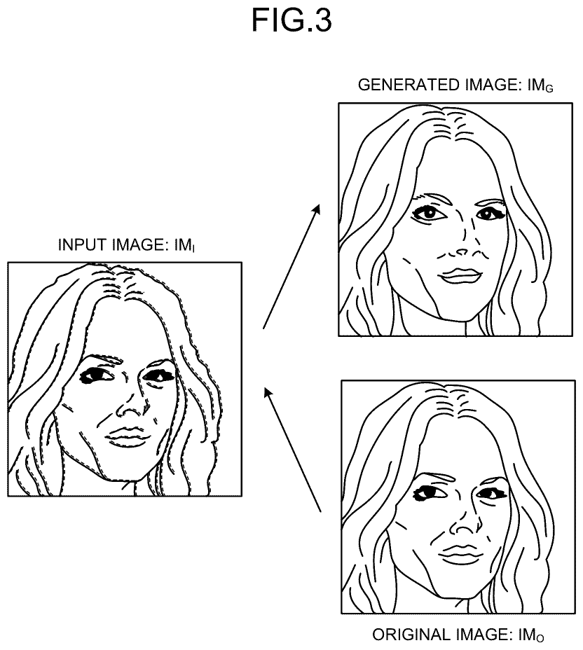

FIGS. 2 and 3 are diagrams illustrating a change in a human face due to super-resolution processing.

In the example of FIG. 2, a male face is a processing target. An input image IM_{I} is generated by reducing the resolution of the original image IM_{O}. Due to the reduction in resolution, a part of information such as the contour of the face parts such as the eyes, the nose, and the mouth, and the texture of the skin is lost. In the super-resolution processing, lost information is restored (generated) based on a learning result of machine learning. However, if there is a deviation between the restored information and the original information, the human face changes.

In the example of FIG. 2, a generated image IM_{G} in which the size and shape of the eyes, the density of beard or hair, and the gloss or wrinkle of the skin are slightly different from those of the original image IM_{O} is output. Since the shape of the eye greatly affects the human face, it is felt that the human face is changed even if the size and shape of the eye are slightly changed.

In the example of FIG. 3, the generated image IM_{G} in which the size and shape of the eyes, the shape of the ridge of the nose, the texture of the hair, the shape of the lips, the degree of elevation of the corners of the mouth, or the like are slightly different from those of the original image IM_{O} is output. As the shapes of the face parts such as the eyes, the mouth, and the nose change, the appearance impression changes greatly.

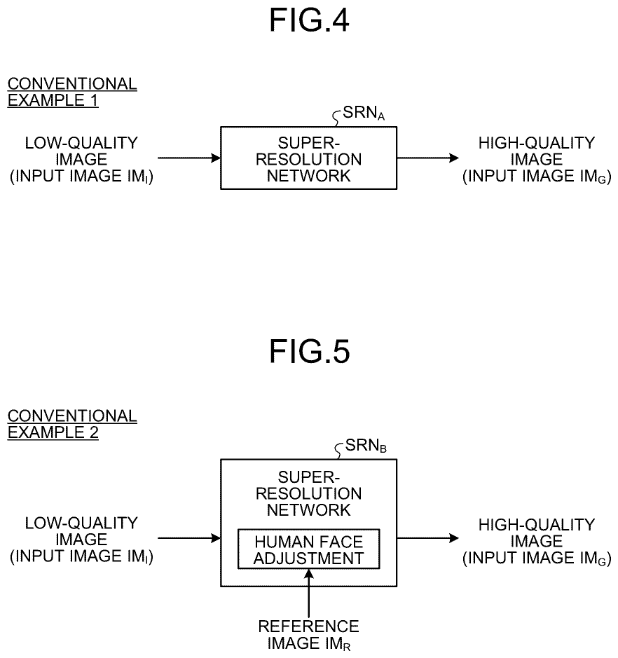

FIGS. 4 and 5 are diagrams illustrating an example of a conventional super-resolution processing system.

FIG. 4 illustrates a general super-resolution network SRN_{A} using GAN. In the super-resolution network SRN_{A}, the resolution of the generated image IM_{G} is increased by a strong generation force, but it is difficult to control an unexpected generation result. The reason is that it is difficult to clarify the dependency relationship between input and output obtained by machine learning, and the learning process is also complicated, in a manner that it is not possible to practically correct the generated image IM_{G} as intended. In addition, since the learning process cannot be controlled, it is difficult to correct only a specific input even if the processing result for the specific input result is wrong.

FIG. 5 illustrates a super-resolution network SRN_{B} using the face image of the same person as a reference image IM_{R}. This type of super-resolution network SRN_{B} is disclosed in Non Patent Literature 1. The super-resolution network SRN_{B} dynamically adjusts a part of the parameters used for the super-resolution processing using the feature information of the reference image IM_{R}. As a result, a human face image close to the reference image IM_{R} is generated. However, since the causal relationship between the reference image IM_{R} and the output result is acquired by deep learning, a completely matching human face is not generated in all cases. Therefore, even if the super-resolution network SRN_{B} is used, the change in the human face cannot be completely suppressed.

Therefore, the present disclosure proposes a new method for solving the above-described problem. An information processing device IP of the present disclosure calculates the human face matching degree before and after the super-resolution processing, and adjusts the generation force of a super-resolution network SRN based on the calculated human face matching degree. According to this configuration, the human face of the generated image IM_{G} is fed back to the super-resolution processing. For this reason, a change in a human face due to super-resolution processing hardly occurs.

The information processing device IP can be used for high image quality of old video materials (such as movies and photographs), a highly efficient video compression/transmission system (video telephone, online meeting, relay of live-video, and network distribution of video content), or the like. In the case of enhancing the image quality of a movie or a photograph, high reproducibility is required for the face of the subject, and thus the method of the present disclosure is suitably employed. In a video compression/transmission system, since information of an original video is greatly reduced, a human face change is likely to occur at the time of restoration. Such an adverse effect is avoided by using the method of the present disclosure.

Hereinafter, embodiments of the information processing device IP will be described in detail.

### 2. First Embodiment

### [2-1. Configuration of Information Processing Device]

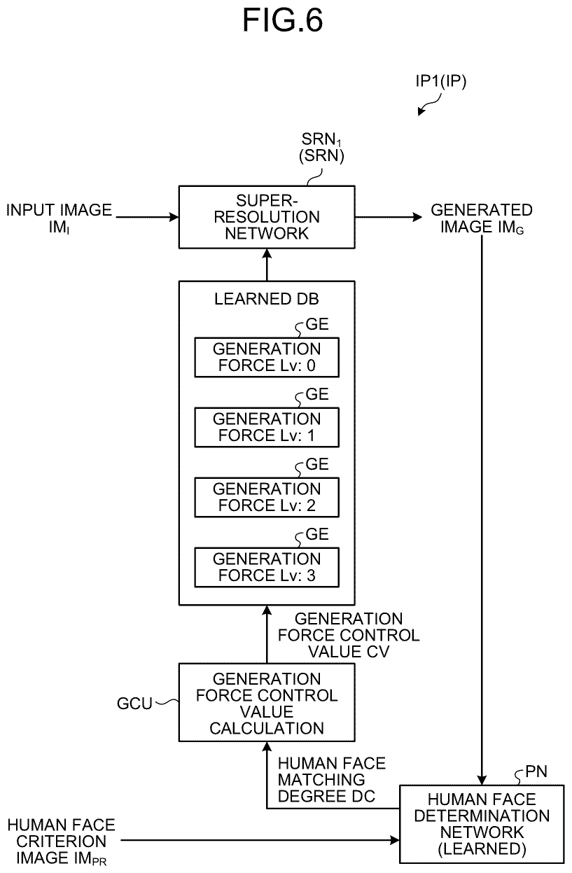

FIG. 6 is a diagram illustrating a configuration of an information processing device IP1 according to a first embodiment.

The information processing device IP1 is a device that restores a high-resolution generated image IM_{G} from an input image IM_{I} using a super-resolution technique. The information processing device IP1 includes a super-resolution network SRN₁, a human face determination network PN, and a generation force control value calculation unit GCU.

The super-resolution network SRN₁ performs super-resolution processing on the input image IM_{I} to generate the generated image IM_{G}. The super-resolution network SRN₁ can change the generation force of the super-resolution processing in a plurality of stages. For example, the super-resolution network SRN₁ includes generators GE of a plurality of GANs having different generation force levels LV. In the example of FIG. 6, four generators GE (generation force levels LV=0 to 3) are held in the learned database, but the number of generators GE is not limited to four. The number of generators GE may be two or more.

The plurality of generators GE is generated using the same neural network. The plurality of generators GE have different parameters used for optimizing the neural network. Since the parameters used for optimization are different, there is a difference in the generation force levels LV of generators GE.

The super-resolution network SRN₁ may acquire a face image of the same person as the subject of the input image IM_{I} as a human face criterion image IM_{PR}. The super-resolution network SRN₁ can perform super-resolution processing of the input image IM_{I} using the feature information of the human face criterion image IM_{PR}. The human face criterion image IM_{PR} is used as the reference image IM_{R} for adjusting the human face. For example, the super-resolution network SRN₁ dynamically adjusts a part of the parameters used for the super-resolution processing using the feature information of the human face criterion image IM_{PR}. As a result, the generated image IM_{G} of the human face close to the human face criterion image IM_{PR} is obtained. As a method of the human face adjustment using the human face criterion image IM_{PR}, a known method described in Non Patent Literature 1 or the like is used.

The human face determination network PN calculates a human face matching degree DC between the input image IM_{I} before being subjected to the super-resolution processing and the input image IM_{I} after being subjected to the super-resolution processing. The human face determination network PN is a neural network that performs face recognition. For example, the human face determination network PN calculates the similarity between the face of the person included in the generated image and the face of the same person included in the human face criterion image as the human face matching degree DC. The similarity is calculated with a known face recognition technique using feature point matching or the like.

The super-resolution network SRN₁ adjusts the generation force of the super-resolution processing based on the human face matching degree DC. For example, the super-resolution network SRN₁ selects and uses the generator GE in which the human face matching degree DC satisfies the acceptance criterion from the plurality of generators GE having different generation force levels LV. The super-resolution network SRN₁ determines whether or not the human face matching degree DC satisfies the acceptance criterion in order from the generator GE having the higher generation force level LV. The super-resolution network SRN₁ selects and uses the generator GE that is first determined to satisfy the acceptance criterion.

The generation force control value calculation unit GCU calculates a generation force control value CV based on the human face matching degree DC. The generation force control value CV indicates a lowering width from the current generation force level LV. The lowering width is larger as the human face matching degree DC is lower. The super-resolution network SRN₁ calculates the generation force level LV based on the generation force control value CV. The super-resolution network SRN₁ performs the super-resolution processing using the generator GE corresponding to the calculated generation force level LV.

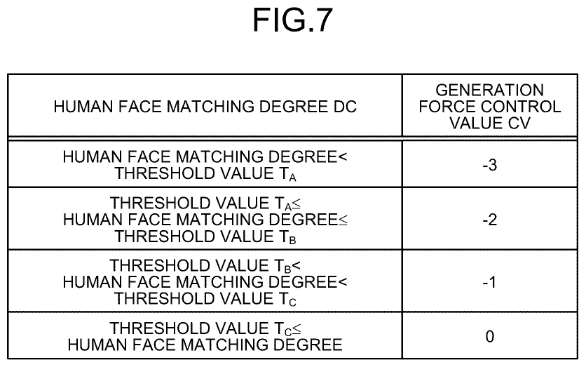

FIG. 7 is a diagram illustrating an example of a relationship between the human face matching degree DC and the generation force control value CV.

In the example of FIG. 7, a threshold value T_{A}, a threshold value T_{B}, and a threshold value T_{C} (threshold value T_{A}<threshold value T_{B}<threshold value T_{C}) are set as the acceptance criteria. For example, in a case where the human face matching degree DC is smaller than the threshold value T_{A}, the generation force control value CV is set to (−3). In a case where the human face matching degree DC is equal to or larger than the threshold value T_{A} and smaller than the threshold value T_{B}, the generation force control value CV is set to (−2). In a case where the human face matching degree Dc is equal to or larger than the threshold value T_{B} and smaller than the threshold value T_{C}, the generation force control value CV is set to (−1). In a case where the human face matching degree DC is equal to or larger than the threshold value T_{C}, the generation force control value CV is set to 0. By setting the lowering width of the generation force level LV in stages according to the human face matching degree DC, an appropriate generator GE is quickly detected.

### [2-2. Information Processing Method]

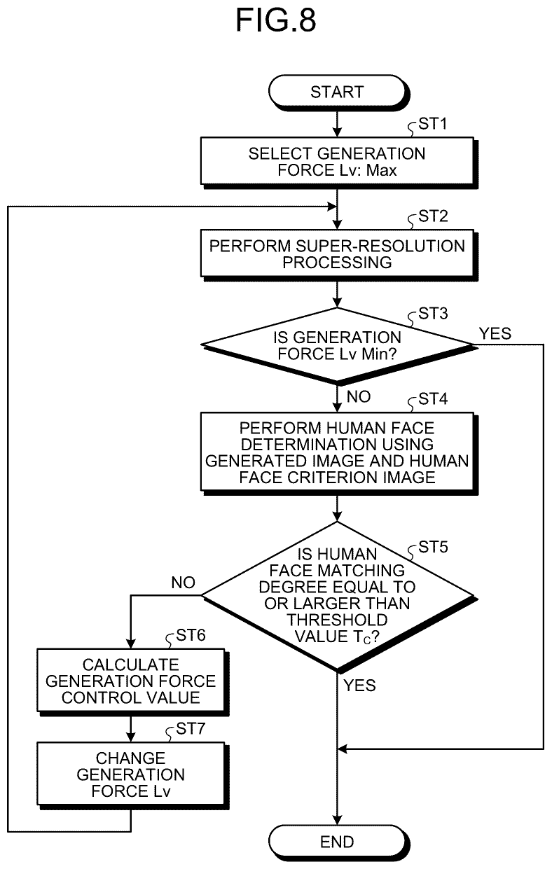

FIG. 8 is a flowchart illustrating an example of information processing of the information processing device IP1.

In step ST1, the super-resolution network SRN₁ selects the generator GE having the maximum generation force level LV. In step ST2, the super-resolution network SRN₁ performs the super-resolution processing using the selected generator GE.

In step ST3, the super-resolution network SRN₁ determines whether or not the generation force level LV of the currently selected generator GE is minimum. In a case where it is determined in step ST3 that the generation force level LV is the minimum (step ST3: yes), the super-resolution network SRN₁ continues to use the currently selected generator GE.

In a case where it is determined in step ST3 that the generation force level LV is not the minimum (step ST3: no), the process proceeds to step ST4. In step ST4, the human face determination network PN calculates the human face matching degree DC using the generated image IM_{G} and the human face criterion image IM_{PR}, and performs the human face determination.

In step ST5, the generation force control value calculation unit GCU determines whether or not the human face matching degree DC is equal to or larger than the threshold value T_{C}. In a case where it is determined in step ST5 that the human face matching degree DC is equal to or larger than the threshold value T_{C} (step ST5: yes), the generation force control value calculation unit GCU sets the generation force control value CV to 0. The super-resolution network SRN₁ continuously uses the currently selected generator GE.

In a case where it is determined in step ST5 that the human face matching degree DC is smaller than the threshold value T_{C} (step ST5: no), the process proceeds to step ST6. In step ST6, the generation force control value calculation unit GCU calculates the generation force control value CV corresponding to the human face matching degree DC. In step ST7, the super-resolution network SRN₁ selects the generator GE having the generation force level LV specified by the generation force control value CV. Then, returning to step ST2, the super-resolution network SRN₁ performs the super-resolution processing using the generator GE having the generation force level LV after the change. After that, the above-described processing is repeated.

### [2-3. Learning Method]

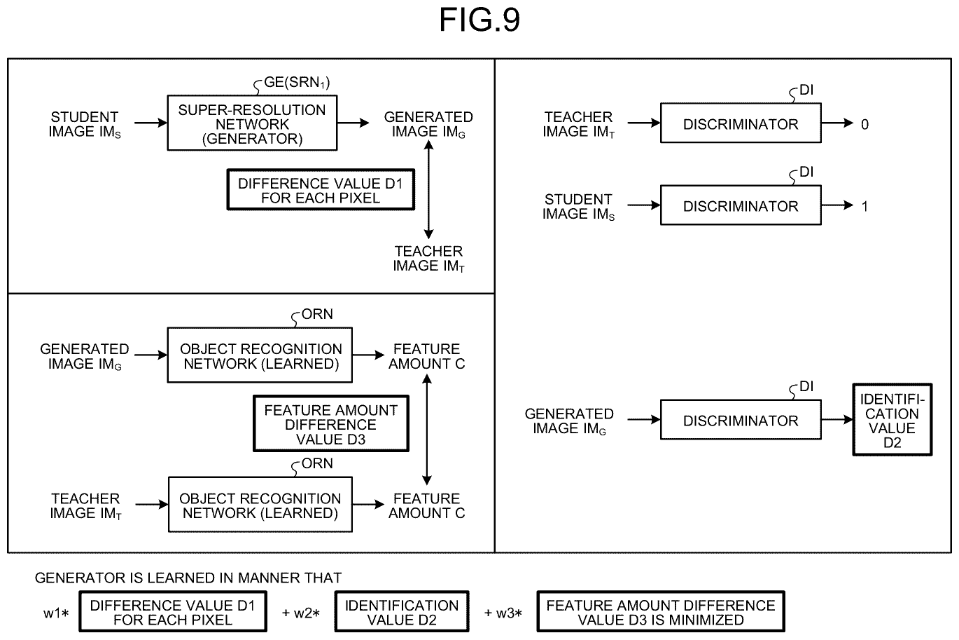

FIG. 9 is a diagram illustrating an example of a learning method of the super-resolution network SRN₁.

The super-resolution network SRN₁ includes generators GE of a plurality of GANs machine-learned using a student image IM_{S} and the generated image IM_{G}. The student image IM_{S} is input data for machine learning in which the resolution of a teacher image IM_{T} is reduced. The generated image IM_{G} is output data obtained by performing super-resolution processing on the student image IM_{S}. For the teacher image IM_{T}, face images of various persons are used.

In the generator GE of the GAN, machine learning is performed in a manner that the difference between the generated image IM_{G} and the teacher image IM_{T} becomes small. In a discriminator DI of the GAN, machine learning is performed in a manner that the identification value when the teacher image IM_{T} is input is 0 and the identification value when the student image IM_{S} is input is 1. A feature amount C is extracted from each of the generated image IM_{G} and the teacher image IM_{T} by an object recognition network ORN. The object recognition network ORN is a learned neural network that extracts the feature amount C of the image. In the generator GE, machine learning is performed in a manner that the difference between the feature amount C of the generated image IM_{G} and the feature amount C of the teacher image IM_{T} becomes small.

For example, the difference value between the teacher image IM_{T} and the generated image IM_{G} for each pixel is D1. The identification value of the discriminator DI is D2. The difference value of the feature amount C between the teacher image IM_{T} and the generated image IM_{G} is D3. The weight of the difference value D1 is w1. The weight of the identification value D2 is w2. The weight of the difference value D3 is w3. In each GAN, machine learning is performed in a manner that the weighted sum (w1×D1+w2×D2+w3×D3) of the difference value D1, the identification value D2, and the difference value D3 is minimized. The ratio of the weight w1, the weight w2, and the weight w3 is different for each GAN.

The GAN is a widely known convolutional neural network (CNN), and performs learning by minimizing the weighted sum of the above-described three values (difference value D1, identification value D2, and difference value D3). The optimum values of the three weights w1, w2, and w3 change depending on the CNN used for learning, the learning data set, or the like. Usually, an optimum set of values is used to obtain the maximum generation force, but in the present disclosure, by changing the three weights w1, w2, and w3, learning results with different generation forces can be obtained in stages while using the same CNN.

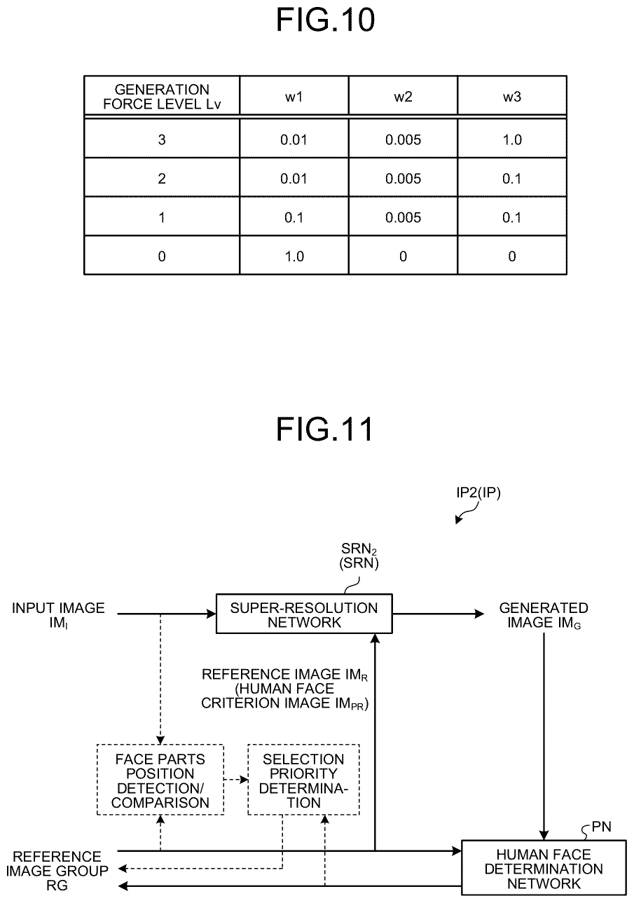

FIG. 10 is a diagram illustrating an example of a combination of the weights w1, w2, and w3 corresponding to the generation force level LV.

The Enhanced Super-Resolution Generative Adversarial Networks (ESRGAN) are known as a representative CNNs for super-resolution processing using GAN. ESRGAN is described in [1]below.
[1] Xintao Wang, Ke Yu, Shixiang Wu, Jinjin Gu, Yihao Liu, Chao Dong, Yu Qiao, Chen Change Loy, “ESRGAN: Enhanced Super-Resolution Generative Adversarial Networks”, Published in ECCV Workshops 2018

For example, in the present disclosure, the generator GE of ESRGAN is applied to the super-resolution network SRN₁. The generator GE having a higher generation force level LV has a higher ratio of the weight w2 and the weight w3 to the weight w1. The generator GE having a lower generation force level LV has a lower ratio of the weight w2 and the weight w3 to the weight w1.

In the example of FIG. 10, when w1=1.0, w2=0, and w3=0, the generator GE with the generation force level=0 is obtained. When w1=0.1, w2=0.05, and w3=0.1, the generator GE with the generation force level=1 is obtained. When w1=0.01, w2=0.05, and w3=0.1, the generator GE with the generation force level=2 is obtained. When w1=0.01, w2=0.05, and w3=1.0, the generator GE with the generation force level=3 is obtained.

Note that the values of the weights w1, w2, and w3 can change depending on conditions such as the configuration of the neural network, the number of images of the learning data set, the content of the image, and the learning rate of the CNN. Even in a combination of values of different weights, the learning result may converge to an optimum value under the same condition.

### [2-4. Effects]

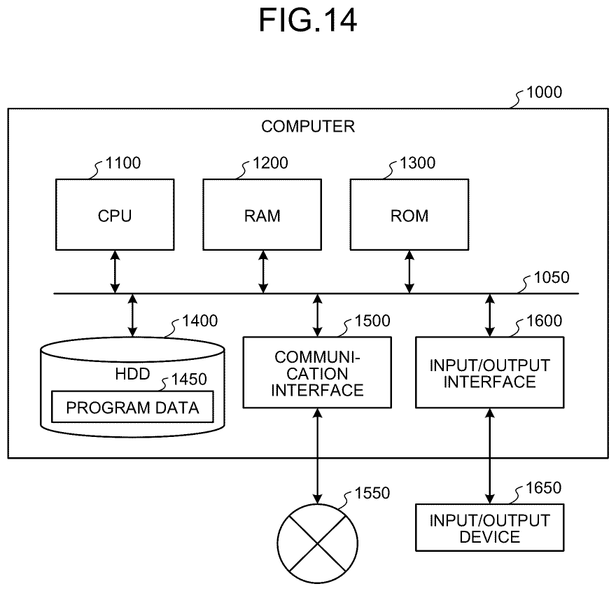

The information processing device IP1 includes the human face determination network PN and the super-resolution network SRN₁. The human face determination network PN calculates a human face matching degree DC between the input image IM_{I} before being subjected to the super-resolution processing and the input image IM_{I} after being subjected to the super-resolution processing. The super-resolution network SRN₁ adjusts the generation force of the super-resolution processing based on the human face matching degree DC. In the information processing method of the present disclosure, the processing of the information processing device IP1 is executed by a computer 1000 (see FIG. 14). The program of the present disclosure (program data 1450: see FIG. 14) causes the computer 1000 to implement the processing of the information processing device IP1.

According to this configuration, the generation force of the super-resolution network SRN₁ is adjusted based on the change in the human face before and after the super-resolution processing. Therefore, a change in a human face due to super-resolution processing is suppressed.

The super-resolution network SRN₁ selects and uses the generator GE in which the human face matching degree DC satisfies the acceptance criterion from the plurality of generators GE having different generation force levels LV.

According to this configuration, the generation force of the super-resolution network SRN₁ is adjusted by the selection of the generator GE.

The super-resolution network SRN₁ includes the generators GE of a plurality of GANs machine-learned using a student image IM_{S} obtained by reducing the resolution of the teacher image IM_{T} and a generated image IM_{G} obtained by performing super-resolution processing on the student image IM_{S}. The difference value between the teacher image IM_{T} and the generated image IM_{G} for each pixel is D1, the identification value of the discriminator DI of the GAN is D2, the difference value of the feature amount C between the teacher image IM_{T} and the generated image IM_{G} is D3, the weight of the difference value D1 is w1, the weight of the identification value D2 is w2, and the weight of the difference value D3 is w3. In each GAN, machine learning is performed in a manner that the weighted sum (w1×D1+w2×D2+w3×D3) of the difference value D1, the identification value D2, and the difference value D3 is minimized. The ratio of the weight w1, the weight w2, and the weight w3 is different for each GAN.

According to this configuration, the neural network of each generator GE can be made common. In addition, the generation force of each generator GE can be easily controlled by the ratio of the weight w1, the weight w2, and the weight w3.

The super-resolution network SRN₁ determines whether or not the human face matching degree satisfies the acceptance criterion in order from the generator GE having the higher generation force level LV. The super-resolution network SRN₁ selects and uses the generator GE that is first determined to satisfy the acceptance criterion.

According to this configuration, the generator GE having the maximum allowable generation force is selected.

The information processing device IP1 includes the generation force control value calculation unit GCU. The generation force control value calculation unit GCU calculates the generation force control value CV indicating a lowering width from the current generation force level LV based on the human face matching degree DC. The lowering width is larger as the human face matching degree DC is lower.

According to this configuration, an appropriate generator GE is quickly detected.

The super-resolution network SRN₁ performs super-resolution processing of the input image IM_{I} using the feature information of the human face criterion image IM_{PR}.

According to this configuration, the human face matching degree DC before and after the super-resolution processing is increased.

Note that the effects described in the present specification are merely examples and are not limited, and other effects may be provided.

### 3. Second Embodiment

### [3-1. Configuration of Information Processing Device]

FIG. 11 is a diagram illustrating a configuration of an information processing device IP2 according to a second embodiment.

The present embodiment is different from the first embodiment in that the generation force of the super-resolution network SRN₂ is adjusted by switching the human face criterion image IM_{PR}. Hereinafter, differences from the first embodiment will be mainly described.

In the first embodiment, the plurality of generators GE is switched and used based on the human face matching degree DC. However, in the present embodiment, only one generator GE is used. The super-resolution network SRN₂ performs super-resolution processing of the input image IM_{I} using the feature information of the human face criterion image IM_{PR}. The super-resolution network SRN₂ selects, as the human face criterion image IM_{PR}, the reference image IM_{R} of which the human face matching degree DC satisfies the acceptance criterion from the plurality of reference images IM_{R} included in a reference image group RG.

The reference image group RG is acquired from image data inside or outside the information processing device IP2. For example, in a case where the person appearing in the input image IM_{I} is a celebrity, a plurality of reference images IM_{R} (reference image group RG) capable of specifying the human face of the target person is acquired from the Internet or the like. In a case where the input image IM_{I} is an image of a certain scene of a past video (such as a movie), an image group that can be the reference image IM_{R} is extracted from an up scene of a face of another scene in the same video. In a case where the person appearing in the input image IM_{I} is the user of the information processing device IP2 and the information processing device IP2 is a device having a camera function such as a smartphone, an image group that can be the reference image IM_{R} is extracted from the photograph data stored in the information processing device IP2.

From the reference image group RRG, the reference image IM_{R} suitable for the human face determination is sequentially selected as the human face criterion image IM_{PR}. The super-resolution network SRN₂ determines the priority with respect to the plurality of reference images IM_{R}, and selects each reference image IM_{R} as the human face criterion image IM_{PR} according to the priority. For example, the super-resolution network SRN₂ determines whether or not the human face matching degree DC satisfies the acceptance criterion in order from the reference image IM_{R} in which the posture, size, and position of the face of the subject are close to the input image IM_{I}. The super-resolution network SRN₂ selects the reference image IM_{R} that is first determined to satisfy the acceptance criterion as the human face criterion image IM_{PR}. As a result, the super-resolution processing is performed with the maximum allowable generation force.

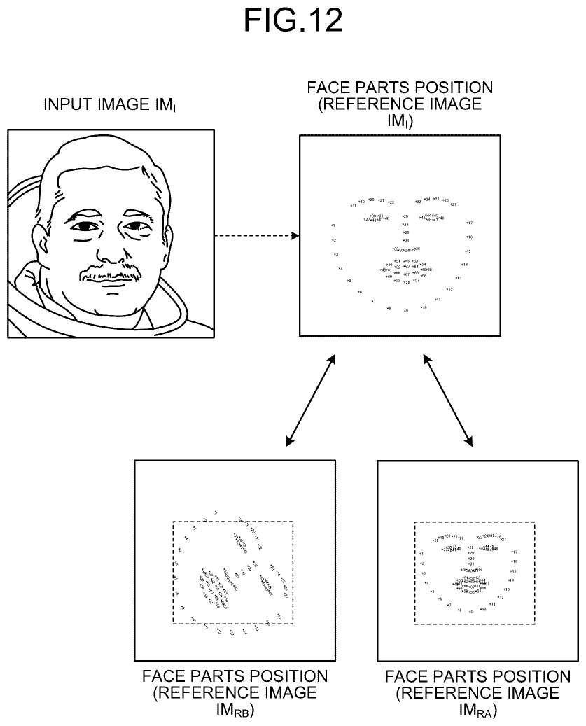

FIG. 12 is a diagram illustrating an example of a method of comparing a posture, a size, and a position of a face.

In the super-resolution network SRN₂, left and right eyes, eyebrows, a nose, upper and lower lips, a lower jaw, or the like are preset as face parts to be compared. The super-resolution network SRN₂ extracts the coordinates of each point on the contour line of the face part from the input image IM_{I} and the reference image IM_{R}. The detection of the face parts is performed using, for example, a known face recognition technology described in [2] below.
[2] Kazemi, V., &Josephine, S. “One Millisecond Face Alignment with an Ensemble of Regression Trees. Computer Vision and Pattern Recognition (CVPR)”, 2014

The super-resolution network SRN₂ extracts points (corresponding points) corresponding to each other in the input image IM_{I} and the reference image IM_{R} by using a method such as corresponding point matching. In the super-resolution network SRN₂, the reference image IM_{R} having a smaller sum of the absolute values of the differences between the coordinates of the corresponding points of the input image IM_{I} and the reference image IM_{R} has a higher priority. As a result, an appropriate human face criterion image IM_{PR} is quickly detected. In the example of FIG. 12, the posture of the face parts of the reference image IM_{RA} is closer to the input image IM_{I} than the posture of the face parts of the reference image IM_{RB}. For this reason, the priority of the reference image IM_{RA} is set higher than that of the reference image IM_{RB}.

### [3-2. Information Processing Method]

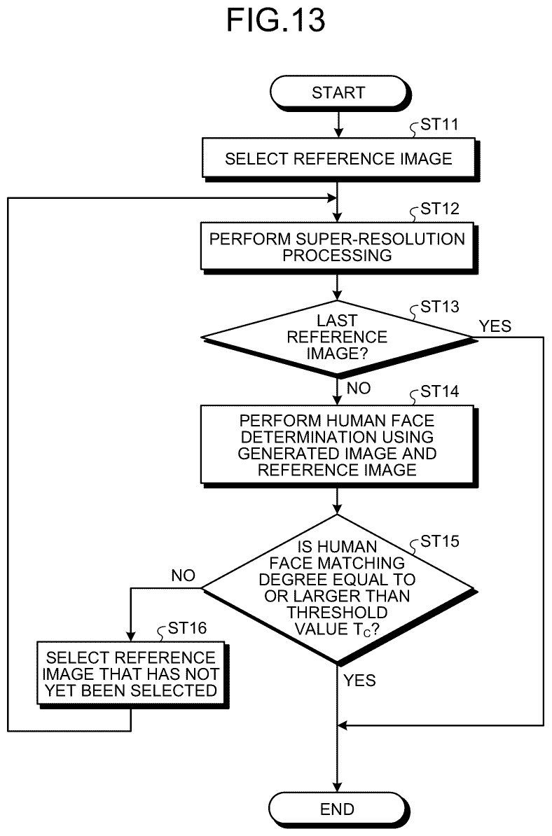

FIG. 13 is a flowchart illustrating an example of information processing of the information processing device IP2.

In step ST11, the super-resolution network SRN₂ selects one reference image IM_{R} according to the priority from the reference image group RG as the human face criterion image IM_{PR}. In step ST12, the super-resolution network SRN₂ performs the super-resolution processing using the feature information of the selected reference image IM_{R}.

In step ST13, the super-resolution network SRN₂ determines whether or not the current reference image IM_{R} selected as the human face criterion image IM_{PR} is the last reference image IM_{R} according to the priority. In a case where it is determined in step ST13 that the current reference image IM_{R} is the last reference image IM_{R} (step ST13: yes), the super-resolution network SRN₂ continuously uses the currently selected reference image IM_{R} as the human face criterion image IM_{PR}.

In a case where it is determined in step ST13 that the current reference image IM_{R} is not the last reference image IM_{R}(step ST13: no), the process proceeds to step ST14. In step ST14, the super-resolution network SRN₂ calculates the human face matching degree DC using the generated image IM_{G} and the currently selected reference image IM_{R}, and performs the human face determination.

In step ST15, the super-resolution network SRN₂ determines whether or not the human face matching degree DC is equal to or larger than the threshold value T_{C}. In a case where it is determined in step ST15 that the human face matching degree DC is equal to or larger than the threshold value T_{C} (step ST15: yes), the super-resolution network SRN₂ continuously uses the currently selected reference image IM_{R} as the human face criterion image IM_{PR}.

In a case where it is determined in step ST15 that the human face matching degree DC is smaller than the threshold value T_{C} (step ST15: no), the process proceeds to step ST16. In step ST16, the super-resolution network SRN₂ selects the reference image IM_{R} that has not yet been selected as the human face criterion image IM_{PR} according to the priority. Then, the process returns to step ST12, and the super-resolution network SRN₂ performs the super-resolution processing using the newly selected reference image IM_{R}. After that, the above-described processing is repeated.

### [3-3. Effects]

The super-resolution network SRN₂ according to the present embodiment selects, as the human face criterion image IM_{PR}, the reference image IM_{R} of which the human face matching degree DC satisfies the acceptance criterion from the plurality of reference images IM_{R}. According to this configuration, the generation force of the super-resolution network SRN₂ is adjusted according to the selection of the human face criterion image IM_{PR}. For this reason, a change in a human face due to super-resolution processing is suppressed.

### [4. Hardware Configuration Example]

FIG. 14 is a diagram illustrating a hardware configuration example of the information processing device IP. For example, the information processing device IP is realized by the computer 1000. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on the program stored in the ROM 1300 or an HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that performs non-transient recording of a program executed by the CPU 1100, data used by such a program, and the like. Specifically, the HDD 1400 is a recording medium that records an information processing program according to the present disclosure as an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. In addition, the input/output interface 1600 may function as a media interface that reads a program and the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing device IP, the CPU 1100 of the computer 1000 executes the program loaded on the RAM 1200 to implement various functions for super-resolution processing. In addition, the HDD 1400 stores a program for causing the computer to function as the information processing device IP. Note that the CPU 1100 reads the program data 1450 from the HDD 1400 and executes the program data, but as another example, these programs may be acquired from another device via the external network 1550.

### [Appendix]

Note that the present technology can also have the configuration below.

(1)

An information processing device comprising:
a human face determination network that calculates a human face matching degree between an input image before being subjected to super-resolution processing and the input image after being subjected to the super-resolution processing; and
a super-resolution network that adjusts a generation force of the super-resolution processing based on the human face matching degree.
   (2)

The information processing device according to (1), wherein
the super-resolution network selects and uses a generator in which the human face matching degree satisfies an acceptance criterion from a plurality of generators having different generation force levels.
   (3)

The information processing device according to (2), wherein
the super-resolution network includes a generator of a plurality of GANs machine-learned using a student image obtained by reducing resolution of a teacher image and a generated image obtained by performing super-resolution processing on the student image, and
when a difference value for each pixel between the teacher image and the generated image is D1, an identification value of a discriminator of the GAN is D2, a difference value of a feature amount between the teacher image and the generated image is D3, a weight of the difference value D1 is w1, a weight of the identification value D2 is w2, and a weight of the difference value D3 is w3,
in each GAN, machine learning is performed in a manner that a weighted sum (w1×D1+w2×D2+w3×D3) of the difference value D1, the identification value D2, and the difference value D3 is minimized, and
a ratio of the weight w1, the weight w2, and the weight w3 is different for each GAN.
   (4)

The information processing device according to (2) or (3), wherein
the super-resolution network determines whether or not the human face matching degree satisfies the acceptance criterion in order from a generator having the higher generation force level, and selects and uses a generator determined to satisfy the acceptance criterion first.
   (5)

The information processing device according to any one of (2) to (4), comprising:
a generation force control value calculation unit that calculates a generation force control value indicating a lowering width from the current generation force level based on the human face matching degree, wherein
the lowering width is larger as the human face matching degree is lower.
   (6)

The information processing device according to any one of (2) to (5), wherein
the super-resolution network performs super-resolution processing on the input image by using feature information of a human face criterion image.
   (7)

The information processing device according to (1), wherein
the super-resolution network performs super-resolution processing on the input image by using feature information of a human face criterion image, and
the super-resolution network selects, as the human face criterion image, a reference image having the human face matching degree that satisfies an acceptance criterion from a plurality of reference images.
   (8)

The information processing device according to (7), wherein
the super-resolution network determines whether or not the human face matching degree satisfies the acceptance criterion in order from a reference image in which a posture, a size, and a position of a face of a subject are close to the input image, and selects the reference image that is first determined to satisfy the acceptance criterion as the human face criterion image.
   (9)

The information processing device according to (8), wherein
the super-resolution network extracts coordinates of each point on a contour line of a face part from the input image and the reference image, and sets the reference image having a smaller sum of absolute values of differences between the coordinates of corresponding points of the input image and the reference image to have a higher priority.
   (10)

An information processing method executed by a computer, the method comprising:
calculating a human face matching degree between an input image before being subjected to super-resolution processing and the input image after being subjected to the super-resolution processing; and
adjusting a generation force of the super-resolution processing based on the human face matching degree.
   (11)

A program for causing a computer to implement:
calculating a human face matching degree between an input image before being subjected to super-resolution processing and the input image after being subjected to the super-resolution processing; and
adjusting a generation force of the super-resolution processing based on the human face matching degree.

### REFERENCE SIGNS LIST

C FEATURE AMOUNT
CV GENERATION FORCE CONTROL VALUE
D1, D3 DIFFERENCE VALUE
D2 IDENTIFICATION VALUE
DC HUMAN FACE MATCHING DEGREE
DI DISCRIMINATOR
GCU GENERATION FORCE CONTROL VALUE CALCULATION UNIT
GE GENERATOR
IMG GENERATED IMAGE
IM_{I} INPUT IMAGE
IM_{PR} HUMAN FACE CRITERION IMAGE
IM_{R} REFERENCE IMAGE
IM_{S} STUDENT IMAGE
IM_{T} TEACHER IMAGE
IP, IP1, IP2 INFORMATION PROCESSING DEVICE
LV GENERATION FORCE LEVEL
PN HUMAN FACE DETERMINATION NETWORK
SRN, SRN₁, SRN₂ SUPER-RESOLUTION NETWORK
w1, w2, w3 WEIGHT

1. An information processing device comprising:
a human face determination network that calculates a human face matching degree between an input image before being subjected to super-resolution processing and the input image after being subjected to the super-resolution processing; and
a super-resolution network that adjusts a generation force of the super-resolution processing based on the human face matching degree.

2. The information processing device according to claim 1, wherein
the super-resolution network selects and uses a generator in which the human face matching degree satisfies an acceptance criterion from a plurality of generators having different generation force levels.

3. The information processing device according to claim 2, wherein
the super-resolution network includes a generator of a plurality of GANs machine-learned using a student image obtained by reducing resolution of a teacher image and a generated image obtained by performing super-resolution processing on the student image, and
when a difference value for each pixel between the teacher image and the generated image is D1, an identification value of a discriminator of the GAN is D2, a difference value of a feature amount between the teacher image and the generated image is D3, a weight of the difference value D1 is w1, a weight of the identification value D2 is w2, and a weight of the difference value D3 is w3,
in each GAN, machine learning is performed in a manner that a weighted sum (w1×D1+w2×D2+w3×D3) of the difference value D1, the identification value D2, and the difference value D3 is minimized, and
a ratio of the weight w1, the weight w2, and the weight w3 is different for each GAN.

4. The information processing device according to claim 2, wherein
the super-resolution network determines whether or not the human face matching degree satisfies the acceptance criterion in order from a generator having the higher generation force level, and selects and uses a generator determined to satisfy the acceptance criterion first.

5. The information processing device according to claim 2, comprising:
a generation force control value calculation unit that calculates a generation force control value indicating a lowering width from the current generation force level based on the human face matching degree, wherein
the lowering width is larger as the human face matching degree is lower.

6. The information processing device according to claim 2, wherein
the super-resolution network performs super-resolution processing on the input image by using feature information of a human face criterion image.

7. The information processing device according to claim 1, wherein
the super-resolution network performs super-resolution processing on the input image by using feature information of a human face criterion image, and
the super-resolution network selects, as the human face criterion image, a reference image having the human face matching degree that satisfies an acceptance criterion from a plurality of reference images.

8. The information processing device according to claim 7, wherein
the super-resolution network determines whether or not the human face matching degree satisfies the acceptance criterion in order from a reference image in which a posture, a size, and a position of a face of a subject are close to the input image, and selects the reference image that is first determined to satisfy the acceptance criterion as the human face criterion image.

9. The information processing device according to claim 8, wherein
the super-resolution network extracts coordinates of each point on a contour line of a face part from the input image and the reference image, and sets the reference image having a smaller sum of absolute values of differences between the coordinates of corresponding points of the input image and the reference image to have a higher priority.

10. An information processing method executed by a computer, the method comprising:
calculating a human face matching degree between an input image before being subjected to super-resolution processing and the input image after being subjected to the super-resolution processing; and
adjusting a generation force of the super-resolution processing based on the human face matching degree.

11. A program for causing a computer to implement:
calculating a human face matching degree between an input image before being subjected to super-resolution processing and the input image after being subjected to the super-resolution processing; and
adjusting a generation force of the super-resolution processing based on the human face matching degree.
